(19) United States
(12) Patent Application Publication
(10) Pub. No.: US 2025/0233788 A1
(43) Pub. Date: Jul. 17, 2025

(54) HIGH ORDER MODULATION DETECTION USING LATTICE PARTITIONING

(71) Applicant: Lenovo (United States) Inc., Morrisville, NC (US)

(72) Inventors: Abir BEN HADJ FREDJ, Frankfurt am Main (DE); Razvan-Andrei STOICA, Essen (DE)

(21) Appl. No.: 19/097,575

(22) Filed: Apr. 1, 2025

(51) Int. Cl. H04L 27/34; H04L 5/00

(52) U.S. Cl. CPC H04L 27/34; H04L 5/0044

(57) ABSTRACT

Various aspects of the present disclosure relate to signaling procedures that enhance or improve high order modulation detection using lattice partitioning and/or coset codes. For example, the disclosure introduces signaling procedures that employ sequence coding and lattice set partitioning of M-ary quadrature amplitude modulation (QAM) constellations, where sequence coding (or lattice coding) is inserted between the channel coding and the modulation of bits of data.

### TECHNICAL FIELD

The present disclosure relates to wireless communications, and more specifically to signaling procedures associated with high order modulation detection using lattice partitioning.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

Wireless communications systems may support enablement of use cases that arise from deployment of 6G radio access technologies, such as use cases that rely on immersive communication, hyper-reliable and low-latency communication, ubiquitous connectivity, massive communication, artificial intelligence (AI) communication, integrated sensing and communication, and so on. However, to enable these new cases, certain target requirements for wireless communications have been set, such as enhancements in spectral efficiency, energy efficiency, latency, and reliability.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support or implement signaling procedures associated with high order modulation detection using lattice partitioning.

A network entity for wireless communication is described. The network entity may be configured to, capable of, or operable to perform one or more operations as described herein. For example, the network entity may comprise at least one memory and at least one processor coupled with the at least one memory and configured to cause the network entity to perform set partitioning on an M-ary quadrature amplitude modulation (QAM) constellation based on a modulation and coding scheme (MCS) to generate a set of partitions, define one or more look-up tables associated with the set of partitions, wherein the one or more look-up tables correspond to a sequence coding configuration and wherein the sequence coding configuration includes a quantity of partitions within the set of partitions and one or more coset representatives associated with the quantity of partitions, and transmit the sequence coding configuration to a UE.

A method performed or performable by the network entity is described. The method may comprise performing set partitioning on an M-ary QAM constellation based on an MCS to generate a set of partitions, defining one or more look-up tables associated with the set of partitions, wherein the one or more look-up tables correspond to a sequence coding configuration and wherein the sequence coding configuration includes a quantity of partitions within the set of partitions and one or more coset representatives associated with the quantity of partitions, and transmitting the sequence coding configuration to a UE.

In some implementations of the network entity and method described herein, to transmit the sequence coding configuration, the network entity and method may further be configured to, capable of, performed, performable, or operable to transmit the sequence coding configuration via radio resource control (RRC) signaling or downlink control information (DCI).

In some implementations of the network entity and method described herein, to transmit the sequence coding configuration, the network entity and method may further be configured to, capable of, performed, performable, or operable to transmit the sequence coding configuration in a semi-static manner as part of a physical downlink shared channel (PDSCH)-config information element (IE) or a physical uplink shared channel (PUSCH)-config IE.

In some implementations of the network entity and method described herein, the DCI includes an activation or de-activation field associated with activating the UE to perform sequence coding based on the transmitted sequence coding configuration.

In some implementations of the network entity and method described herein, the activation or de-activation field of the DCI is set to 1 to signal sequence coding activation and set to 0 to signal sequence coding de-activation to the UE.

In some implementations of the network entity and method described herein, the activation or de-activation field of the DCI indicates to the UE to de-activate sequence coding when a modulation order is low or a sequence coding gain is low.

In some implementations of the network entity and method described herein, the network entity and method may further be configured to, capable of, performed, performable, or operable to perform the set partitioning for each modulation order of the MCS in an offline manner.

In some implementations of the network entity and method described herein, each row of the one or more look-up tables maps a number of partitions associated with a sequence coding gain, one or more sets of coset representatives within each partition of the set of partitions, and a minimum squared Euclidean distance (MSD) associated with the performed set partitioning.

In some implementations of the network entity and method described herein, the network entity and method may further be configured to, capable of, performed, performable, or operable to apply a mapping function to encoded bits to map the encoded bits into one or more modulation symbols selected from the one or more coset representatives associated with the quantity of partitions.

A UE for wireless communication is described. The UE may be configured to, capable of, or operable to perform one or more operations as described herein. For example, the UE may comprise at least one memory and at least one processor coupled with the at least one memory and configured to cause the UE to receive a sequence coding configuration from a network entity, wherein the sequence coding configuration includes a quantity of partitions within a set of partitions associated with one or more coset representatives that are based on a selected MCS, and perform sequence decoding based on the sequence coding configuration to detect and decode a stream of bits.

A processor for wireless communication is described. The processor may be configured to, capable of, or operable to perform one or more operations as described herein. For example, the processor may comprise at least one memory and at least one controller coupled with the at least one memory and configured to cause the processor to receive a sequence coding configuration from a network entity, wherein the sequence coding configuration includes a quantity of partitions within a set of partitions associated with one or more coset representatives that are based on a selected MCS, and perform sequence decoding based on the sequence coding configuration to detect and decode a stream of bits.

A method performed or performable by the UE is described. The method may comprise receiving a sequence coding configuration from a network entity, wherein the sequence coding configuration includes a quantity of partitions within a set of partitions associated with one or more coset representatives that are based on a selected MCS and performing sequence decoding based on the sequence coding configuration to detect and decode a stream of bits.

In some implementations of the UE, processor, and method described herein, the sequence coding configuration is associated with one or more look-up tables associated with the set of partitions.

In some implementations of the UE, processor, and method described herein, to receive the sequence coding configuration from the network entity, the UE, processor, and method may further be configured to, capable of, performed, performable, or operable to receive the sequence coding configuration via RRC signaling or DCI.

In some implementations of the UE, processor, and method described herein, to receive the sequence coding configuration from the network entity, the UE, processor, and method may further be configured to, capable of, performed, performable, or operable to receive the sequence coding configuration in a semi-static manner as part of a PDSCH-config IE or a PUSCH-config IE.

In some implementations of the UE, processor, and method described herein, the sequence coding configuration includes sequence coding in a dynamic manner based on link adaptation schemes.

In some implementations of the UE, processor, and method described herein, the sequence coding configuration includes sequence coding parameters, and wherein the at least one processor is configured to cause the UE to perform the sequence decoding based on sequence coding parameters.

### BRIEF DESCRIPTION OF THE DRAWINGS

FIG. 1 illustrates an example of a wireless communications system in accordance with aspects of the present disclosure.

FIG. 2 illustrates an example transmission chain with sequence coding in accordance with aspects of the present disclosure.

FIG. 3 illustrates an example receiver chain with sequence decoding in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

The present disclosure relates to methods, apparatuses, and systems that provide, support, implement, and/or introduce signaling procedures associated with high order modulation detection. Wireless communications systems employ channel coding and modulation schemes to transmit data across a network at great distances with efficiency and reliability. For example, the use of super quadrature amplitude modulation (QAM), such as 1024-QAM or 4096-QAM, or other high order modulations, enable the wireless communications system to increase its spectral efficiency for communications.

QAM enables coherent transmission and is based on a combination of phase and amplitude to encode bits of data. For example, each constellation point of a QAM constellation is or represents a unique combination of phase (e.g., represented by the angle) and amplitude (e.g., represented by a distance to a center of the constellation). However, the use of super QAM modulations may result in a decreased minimum Euclidean distance (MSD) for the constellation, which can impact symbol detection and decoding performance, such as in fading channels. Thus, a measured bit-to-symbol mapping may be leveraged to mitigate the reduced MSD of super QAMs and the resulting impact to fading channels on a received signal, enabling a correct detection of the symbols at a receiver.

The technology described herein introduces signaling procedures that employ sequence coding and lattice or set partitioning of QAM constellations, such as M-ary QAM (M-QAM) constellations, where M equals the number/quantity of symbols or constellation points. The signaling procedures may insert sequence coding (or coset coding) between channel coding and modulation of bits of data, increasing the MSD between the sequences, relative to the MSD between the constellation symbols. This increase in the MSD can realize a sequence coding gain.

For example, a transmitter may select sequences based on lattice or set partitioning, selecting sequences at each partition level, such that a resulting MSD doubles from one level to the next level. A sequence coding configuration, therefore, may include a number/quantity of partitions or cosets, coset representatives, and an associated MSD, where each MSD is associated with a number/quantity of cosets and corresponding coset representatives. Thus, the technology may realize increased or enhanced detection of symbols by employing super QAM, among other benefits.

Aspects of the present disclosure are described in the context of a wireless communications system.

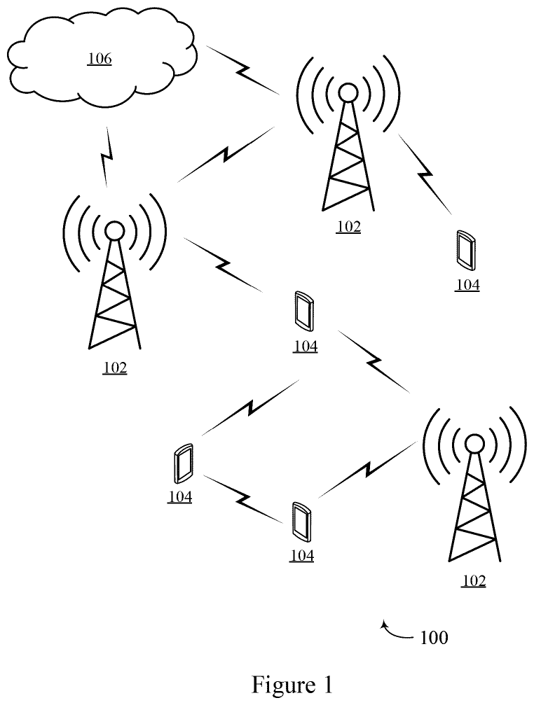

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology provides signaling procedures for enhanced coded modulation using lattice partitions and coset codes for the bit-labeling of low-density parity check (LDPC) encoded bits of data. For example, the signaling procedures may employ configuration signaling (e.g., sequence coding) related to a mapping function ƒ that maps the encoded LDPC bits into coset representatives, which may be constructed using set partitioning techniques. The mapping function maps the encoded bits into one or more modulation symbols, which may be selected from different cosets or lattice/set partitions to enhance the symbol detection capability at a receiver.

The receiver may jointly detect and decode an incoming stream of bits. For example, a transmitter, in addition to coset mapping, may utilize set partitioning to enable higher or realize a higher Euclidean distance between sequences, ensuring resilience and/or mitigating against errors, even when a high order modulation (e.g., super QAM) is used in different channel conditions (e.g., fading channels). The signaling procedures, in some cases, include performing set partitioning based on the modulation order and the code rate as well as tabulating the partitions according to a targeted MSD and/or desired sequence coding gain.

In some examples, the UE 104 may be configured with coset representatives associated with a modulation order and code rate selected by the NE 102. For example, the NE 102 may transmit the configuration (e.g., a sequence coding configuration) to the UE 104 via DCI or RRC signaling. The sequence coding configuration may be configured in a dynamic manner for link adaptation or other purposes.

In some examples, the NE 102 may transmit the sequence coding configuration, along with an MCS, semi-statically via RRC signaling. For example, the NE 102 may transmit the sequence coding configuration in a semi-static manner as part of a physical downlink shared channel (PDSCH)-config information element (IE) or a physical uplink shared channel (PUSCH)-config IE. The configuration may include and/or indicate a number or quantity of cosets, (or a number or quantity of subsets of coset representatives), coset representatives, and/or a target MSD or a threshold for a minimum squared distance that realizes a useful sequence decoding for achieving a targeted sequence coding gain.

In some examples, a sequence coding block may be configured to be dynamically de-activated/activated based on a modulation order and code rates, such as when low modulation is utilized (e.g., binary phase-shift keying (BPSK), quadrature PSK (QPSK), 16-QAM) and the sequence gain is low or a Euclidean distance between constellation symbols is large enough for coherent detection. In some cases, the NE 102 may indicate the sequence coding block to the UE 104 as deactivated via RRC signaling.

The UE 104 may then directly map encoded bits, at the output of a forward error correction (FEC) encoder, into QAM symbols, without going through the sequence encoder. The NE 102 may signal the de-activation/activation configuration semi-statically to the UE 104 via RRC signaling, physical layer signaling (e.g., DCI), and so on. The NE 102 may signal the UE 104 to indicate changes or variations in channel conditions, performing link adaptation. For example, the DCI may include a one-bit field to indicate sequence coding activation/de-activation, as shown in Table 1:

TABLE 1

| Sequence Coding | DCI Field |
|---|---|
| Activate | 1 |
| De-activate | 0 |

In some examples, the NE 102 may signal sequence coding parameters and/or an activation/de-activation configuration via physical layer signaling (e.g., DCI) For example, based on link adaptation techniques, the NE 102 may signal the sequence coding configuration within DCI along with the MCS. As described herein, the sequence coding configuration may include a number or quantity of cosets (or quantity of subsets of coset representatives), the coset representatives, the target MSD or a threshold for a minimum squared distance that realizes a useful sequence decoding to achieve a targeted sequence coding gain.

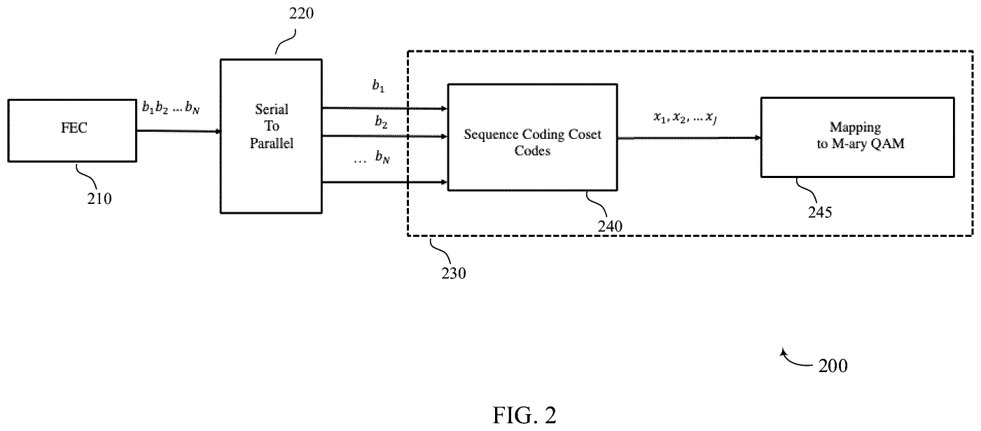

FIG. 2 illustrates an example transmission chain 200 with sequence coding in accordance with aspects of the present disclosure. The transmission chain 200 may be implemented by a transmitter, such as the UE 104. As described herein, an FEC encoder 210 outputs encoded bits to a serial to parallel (S/P) converter 220, which modifies the encoded bits into parallel streams of encoded bits. A modulation block 230 receives the parallel streams of encoded bits. The modulation block 230 includes a M-ary QAM modulation block 245 and a sequence encoder block 240 inserted between the S/P converter 220 and the M-ary QAM modulation block 245.

As described herein, the sequence encoder block 240 may apply a received sequence coding configuration, which includes a quantity of partitions within a set of partitions and one or more coset representatives associated with the quantity of partitions. The sequence encoder block 240 may perform set or lattice partitioning on a QAM constellation received from the M-ary QAM modulation block 245, and based on an MCS, to generate the set of partitions.

In some examples, the sequence coding may be performed by applying a mapping function to the encoded bits. For example, the application of the mapping function (e.g., by the sequence encoder block 240), may be as follows:

$$f : {\{ 0 , 1 \}}^{n} \to 𝒰$$

$${b}_{i} \to f ( {b}_{i} ) = {x}_{i}$$

The mapping function may be tabulated in look-up tables that correspond to different modulation orders and set partitions and/or a number/quantity of cosets for each modulation order. For example, the look-up tables may include a number or quantity of cosets per modulation order and targeted sequence gain, different coset representatives, and/or a corresponding MSD between sequences. Table 2 represents an example look-up table for sequence coding:

TABLE 2

| | Coset | |
|---|---|---|
| Number of cosets | Representatives | Targeted MSD |
| 2 | ( [symbol] ₁, [symbol] ₂) | dₘᵢₙ¹ |
| 3 | ( [symbol] ₁, [symbol] ₂, [symbol] ₃) | dₘᵢₙ² |
| N | ( [symbol] ₁, [symbol] ₂, [symbol] ₃, . . . [symbol] _{N}) | dₘᵢₙ^{N} |

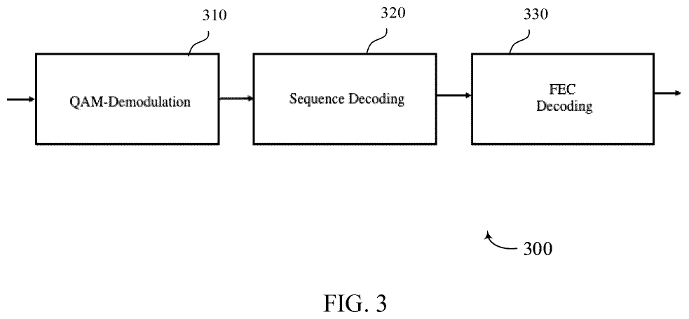

FIG. 3 illustrates an example receiver chain 300 with sequence decoding in accordance with aspects of the present disclosure. The receiver chain 300 may be implemented by a receiver, such as the NE 102 (e.g., a base station). As described herein, a demodulation block 310 performs QAM demodulation to demodulate received bits that are sequence encoded, as described herein. The demodulation block 310 outputs the demodulated bits to a sequence decoder block 320, which decodes the sequences of the bits, outputting the sequence decoded bits (e.g., codewords) to an FEC decoder 330, which decodes the bits and outputs a decoded signal or data.

In some cases, the sequence decoder block 320 may utilize a look-up table (e.g., Table 2) to perform an inverse mapping function that maps back sequences to codewords or encoded bits that will be fed to the FEC decoder. The inverse mapping function may indicate the corresponding bits/encoded bits/codewords (bᵢ) based on detection of a received demodulated symbol xᵢ. An example inverse mapping function is as follows:

$${f}^{- 1} : 𝒰 \to {\{ 0 , 1 \}}^{n}$$

$${x}_{i} \to {f}^{- 1} ( {x}_{i} ) = {b}_{i}$$

As described herein, in some cases, the UE 104 may act or function as the transmitter (based on a received sequence coding configuration) and the NE 102 may act or function as the receiver. In other cases, the UE 104 may act as the receiver (based on a received decoding configuration, similar to the sequence coding configuration) and the NE 102 may act as the transmitter.

In some examples, set partitioning of each of the M-ary QAM modulation constellations may be performed offline. For example, the set partitioning may be performed, at each partition level, such that the MSD between sequences is doubled or alternatively maximized. The NE 102 may then pre-configure and/or tabulate a list of set partitions associated with each of the super QAM modulations. Thus, for each selected MCS index, an associated partitioning may be identified using the MCS index. For example, an MCS index i_{MCS} may be utilized in a formula that indicates a partitioning index i_{Par} within a partition table, as follows:

i_{Par}=ƒ(i_{MCS})

In some examples, the NE 102 may tabulate a limited number of set partitioning (e.g., one or two), corresponding to one or two low modulation orders. For example, the transmitter may perform higher modulation orders corresponding to set partitioning based on the pre-configured sets. The transmitter may perform two or more iterations of set partitioning to achieve a desired sequence coding gain or a targeted MSD. In some cases, the transmitter may determine whether to perform further set partitioning and/or may receive an indication to perform further set partitioning via DCI signaling.

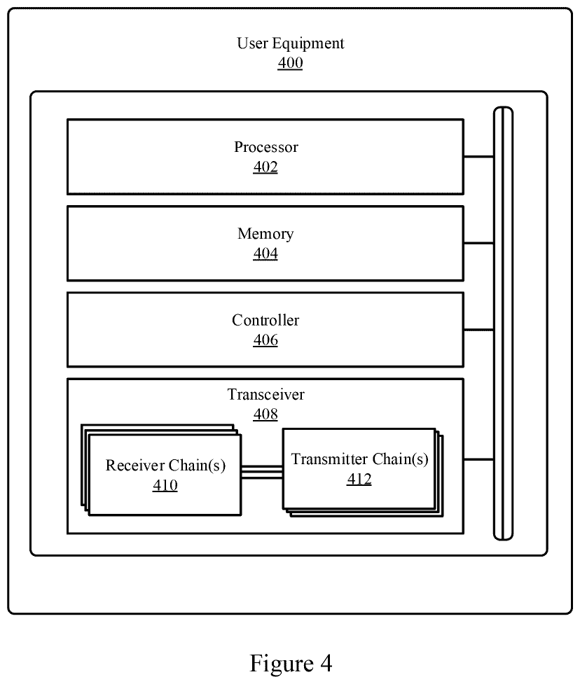

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving a sequence coding configuration from a network entity, wherein the sequence coding configuration includes a quantity of partitions within a set of partitions associated with one or more coset representatives that are based on a selected MCS and performing sequence decoding based on the sequence coding configuration to detect and decode a stream of bits.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

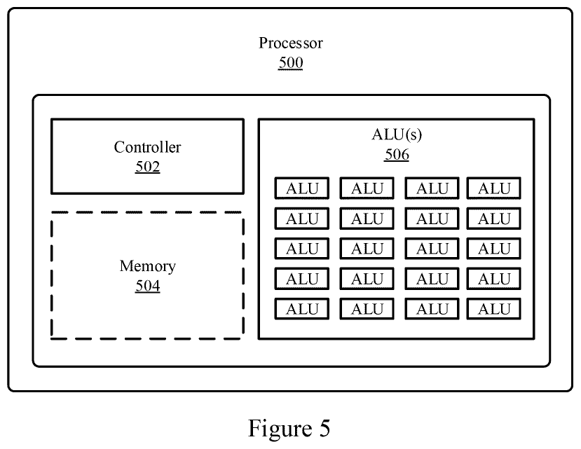

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for receiving a sequence coding configuration from a network entity, wherein the sequence coding configuration includes a quantity of partitions within a set of partitions associated with one or more coset representatives that are based on a selected MCS and performing sequence decoding based on the sequence coding configuration to detect and decode a stream of bits.

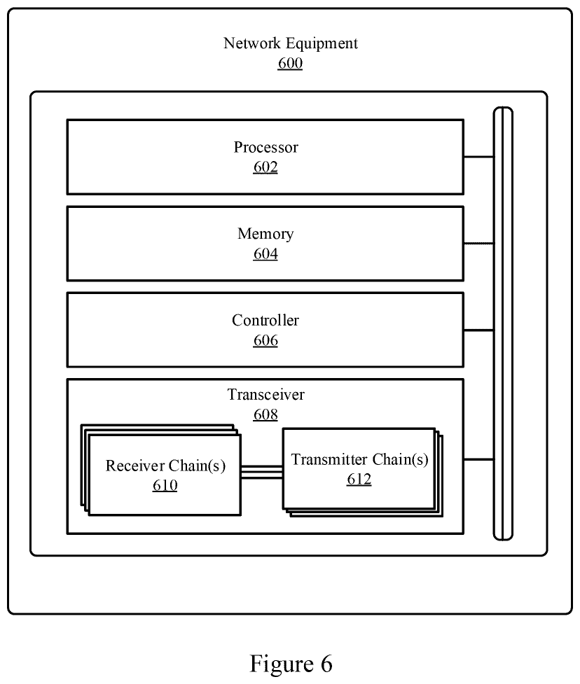

FIG. 6 illustrates an example of a NE 600 in accordance with aspects of the present disclosure. The NE 600 may include a processor 602, a memory 804, a controller 806, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for performing set partitioning on an M-ary QAM constellation based on an MCS to generate a set of partitions, defining one or more look-up tables associated with the set of partitions, wherein the one or more look-up tables correspond to a sequence coding configuration, and wherein the sequence coding configuration includes a quantity of partitions within the set of partitions and one or more coset representatives associated with the quantity of partitions, and transmitting the sequence coding configuration to a UE.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

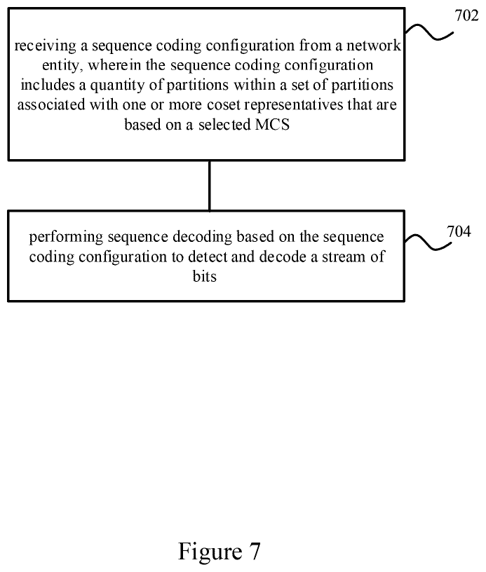

FIG. 7 illustrates a flowchart of a method in accordance with aspects of the present disclosure. The operations of the method may be implemented by a UE (e.g., as a receiver) as described herein. In some implementations, the UE may execute a set of instructions to control the function elements of the UE to perform the described functions.

At 702, the method may include receiving a sequence coding configuration from a network entity, wherein the sequence coding configuration includes a quantity of partitions within a set of partitions associated with one or more coset representatives that are based on a selected MCS. The operations of 702 may be performed in accordance with examples as described herein. In some implementations, aspects of the operations of 702 may be performed by a UE as described with reference to FIG. 4.

At 704, the method may include performing sequence decoding based on the sequence coding configuration to detect and decode a stream of bits. The operations of 704 may be performed in accordance with examples as described herein. In some implementations, aspects of the operations of 704 may be performed a UE as described with reference to FIG. 4.

It should be noted that the method described herein describes a possible implementation, and that the operations and the steps may be rearranged or otherwise modified and that other implementations are possible.

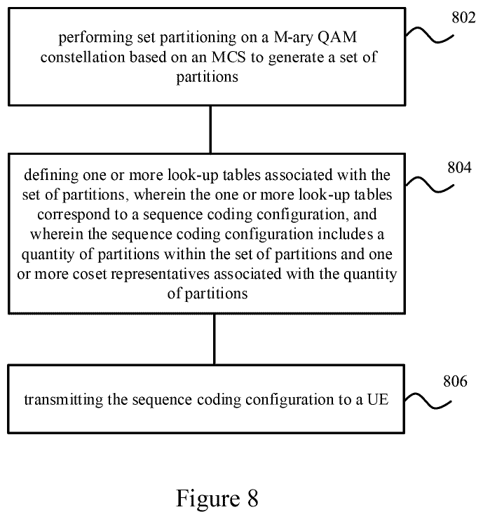

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include performing set partitioning on an M-ary QAM constellation based on an MCS to generate a set of partitions. The operations of 802 may be performed in accordance with examples as described herein. In some implementations, aspects of the operations of 802 may be performed by an NE as described with reference to FIG. 6.

At 804, the method may include defining one or more look-up tables associated with the set of partitions, wherein the one or more look-up tables correspond to a sequence coding configuration, and wherein the sequence coding configuration includes a quantity of partitions within the set of partitions and one or more coset representatives associated with the quantity of partitions. The operations of 804 may be performed in accordance with examples as described herein. In some implementations, aspects of the operations of 804 may be performed by an NE as described with reference to FIG. 6.

At 806, the method may include transmitting the sequence coding configuration to a UE. The operations of 806 may be performed in accordance with examples as described herein. In some implementations, aspects of the operations of 806 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
perform set partitioning on an M-ary quadrature amplitude modulation (QAM) constellation based on a modulation and coding scheme (MCS) to generate a set of partitions;
define one or more look-up tables associated with the set of partitions,
wherein the one or more look-up tables correspond to a sequence coding configuration, and
wherein the sequence coding configuration includes a quantity of partitions within the set of partitions and one or more coset representatives associated with the quantity of partitions; and
transmit the sequence coding configuration to a user equipment (UE).

2. The network entity of claim 1, wherein, to transmit the sequence coding configuration, the at least one processor is configured to cause the network entity to transmit the sequence coding configuration via radio resource control (RRC) signaling or downlink control information (DCI).

3. The network entity of claim 2, wherein, to transmit the sequence coding configuration, the at least one processor is configured to cause the network entity to transmit the sequence coding configuration in a semi-static manner as part of a physical downlink shared channel (PDSCH)-config information element (IE) or a physical uplink shared channel (PUSCH)-config IE.

4. The network entity of claim 2, wherein the DCI includes an activation or de-activation field associated with activating the UE to perform sequence coding based on the transmitted sequence coding configuration.

5. The network entity of claim 4, wherein the activation or de-activation field of the DCI is set to 1 to signal sequence coding activation and set to 0 to signal sequence coding de-activation to the UE.

6. The network entity of claim 4, wherein the activation or de-activation field of the DCI indicates to the UE to de-activate sequence coding when a modulation order is low or a sequence coding gain is low.

7. The network entity of claim 1, wherein the at least one processor is configured to cause the network entity to perform the set partitioning for each modulation order of the MCS in an offline manner.

8. The network entity of claim 1, wherein each row of the one or more look-up tables maps a number of partitions associated with a sequence coding gain, one or more sets of coset representatives within each partition of the set of partitions, and a minimum squared Euclidean distance (MSD) associated with the performed set partitioning.

9. The network entity of claim 1, wherein the least one processor is further configured to cause the network entity to apply a mapping function to encoded bits to map the encoded bits into one or more modulation symbols selected from the one or more coset representatives associated with the quantity of partitions.

10. A user equipment (UE) for wireless communication, comprising:
at least one memory; and
at least one processor coupled with the at least one memory and configured to cause the UE to:
receive a sequence coding configuration from a network entity,
wherein the sequence coding configuration includes a quantity of partitions within a set of partitions associated with one or more coset representatives that are based on a selected modulation and coding scheme (MCS); and
perform sequence decoding based on the sequence coding configuration to detect and decode a stream of bits.

11. The UE of claim 10, wherein the sequence coding configuration is associated with one or more look-up tables associated with the set of partitions.

12. The UE of claim 10, wherein, to receive the sequence coding configuration from the network entity, the at least one processor is configured to cause the UE to receive the sequence coding configuration via radio resource control (RRC) signaling or downlink control information (DCI).

13. The UE of claim 12, wherein, to receive the sequence coding configuration from the network entity, the at least one processor is configured to cause the UE to receive the sequence coding configuration in a semi-static manner as part of a physical downlink shared channel (PDSCH)-config information element (IE) or a physical uplink shared channel (PUSCH)-config IE.

14. The UE of claim 10, wherein the sequence coding configuration includes sequence coding in a dynamic manner based on link adaptation schemes.

15. The UE of claim 10, wherein the sequence coding configuration includes sequence coding parameters, and wherein the at least one processor is configured to cause the UE to perform the sequence decoding based on sequence coding parameters.

16. A method performed by a network entity, the method comprising:
performing set partitioning on a M-ary quadrature amplitude modulation (QAM) constellation based on a modulation and coding scheme (MCS) to generate a set of partitions;
defining one or more look-up tables associated with the set of partitions,
wherein the one or more look-up tables correspond to a sequence coding configuration, and
wherein the sequence coding configuration includes a quantity of partitions within the set of partitions and one or more coset representatives associated with the quantity of partitions; and
transmitting the sequence coding configuration to a user equipment (UE).

17. The method of claim 16, wherein the sequence coding configuration is transmitted via radio resource control (RRC) signaling or downlink control information (DCI).

18. The method of claim 17, wherein the sequence coding configuration is transmitted in a semi-static manner as part of a physical downlink shared channel (PDSCH)-config information element (IE) or a physical uplink shared channel (PUSCH)-config IE.

19. The method of claim 17, wherein the DCI includes an activation or de-activation field associated with activating the UE to perform sequence coding based on the transmitted sequence coding configuration.

20. A method performed by a user equipment (UE), the method comprising:
receiving a sequence coding configuration from a network entity,
wherein the sequence coding configuration includes a quantity of partitions within a set of partitions associated with one or more coset representatives that are based on a selected modulation and coding scheme (MCS); and
performing sequence decoding based on the sequence coding configuration to detect and decode a stream of bits.
